(19) United States
(12) Patent Application Publication
(10) Pub. No.: US 2026/0249656 A1
(43) Pub. Date: Aug. 27, 2026

(54) HEIGHT ADJUSTING TOW HITCH SYSTEMS, VEHICLES, AND METHODS INCLUDING THE SAME

(71) Applicant: Toyota Motor Engineering & Manufacturing North America, Inc., Plano, TX (US)

(72) Inventor: Eric M. Ehlert, Allen Park, MI (US)

(73) Assignees: Toyota Motor Engineering & Manufacturing North America, Inc., Plano, TX (US); Toyota Jidosha Kabushiki Kaisha, Aichi-Ken (JP)

(21) Appl. No.: 19/065,669

(22) Filed: Feb. 27, 2025

(51) Int. Cl. B60D 1/46; B60D 1/06; B60D 1/24

(52) U.S. Cl. CPC B60D 1/465; B60D 1/06; B60D 1/247; B60D 1/248

(57) ABSTRACT

A height adjusting tow hitch system includes: a tow hitch that couples the trailer to the vehicle; a height adjustment mechanism; and an electronic control unit. The height adjustment mechanism couples the tow hitch to the vehicle. The height adjustment mechanism having an actuator configured to linearly displace the tow hitch in a vehicle vertical direction and a height sensor that detects a position of the tow hitch in the vehicle vertical direction. The electronic control unit receives a trailer gross weight of the trailer; determines a tongue weight based on the trailer gross weight and the detected position of the tow hitch; calculates a ratio between the tongue weight and the trailer gross weight; and controls the actuator to adjust the position of the tow hitch in the vehicle vertical direction such that the ratio between the tongue weight and the trailer gross weight is within a predetermined range.

### TECHNICAL FIELD

The present specification generally relates to tow hitch systems for vehicles and, more specifically, tow hitch systems that are configured to adjust a height of a tow hitch based on a ratio of tongue weight to trailer gross weight for proper alignment and stability during travel.

### BACKGROUND

It is known to provide a vehicle with a tow hitch to allow the vehicle to tow a trailer. Currently known tow hitches often require a user to manually adjust a height of the tow hitch to align a trailer coupler of the trailer with the tow hitch. Depending on a size of the vehicle and the trailer, the tow hitch may be higher or lower than the trailer coupler and would require the user to manually adjust the height of the tow hitch to properly align with the trailer coupler before the trailer can be coupled to the vehicle. However, the manual height adjustment can be cumbersome and time consuming for the user.

It is known to provide tow hitch assemblies with a motor to vertically adjust the height of the tow hitch to properly align the tow hitch with the trailer coupler. However, the motorized height adjustment of the tow hitch can lead to an improper height of the tow hitch with respect to the trailer coupler. Specifically, in order to provide stability while the vehicle tows the trailer, a proper ratio of tongue weight to trailer gross weight is needed. As the height of the tow hitch increases, the tongue weight of the trailer hitch decreases, and similarly, as the height of the tow hitch decreases, the tongue weight of the trailer hitch increases. As the currently known motorized tow hitch assemblies do not factor the ratio of tongue weight to trailer gross weight, the currently known motorized tow hitch assemblies may result in an inappropriate ratio of tongue weight to trailer gross weight due to the ease of the motorized tow hitch adjustment by the user.

Accordingly, a need exists for an improved tow hitch system that adjusts a tow hitch height based on the ratio of tongue weight to trailer gross weight for proper alignment and stability during travel.

### SUMMARY

In one embodiment, a height adjusting tow hitch system for a vehicle towing a trailer is provided. The height adjusting tow hitch system includes: a tow hitch; a height adjustment mechanism; and an electronic control unit. The tow hitch is configured to couple the trailer to the vehicle. The height adjustment mechanism couples the tow hitch to the vehicle. The height adjustment mechanism includes an actuator and a height sensor. The actuator is configured to linearly displace the tow hitch in a vehicle vertical direction. The height sensor detects a position of the tow hitch in the vehicle vertical direction. The electronic control unit configured to: receive a trailer gross weight of the trailer; determine a tongue weight based on the trailer gross weight and the detected position of the tow hitch; calculate a ratio between the tongue weight and the trailer gross weight; and control the actuator to adjust the position of the tow hitch in the vehicle vertical direction such that the ratio between the tongue weight and the trailer gross weight is within a predetermined range.

In another embodiment, a vehicle configured to tow a trailer is provided. The vehicle includes: a tow hitch; a height adjustment mechanism; and an electronic control unit. The tow hitch is configured to couple the trailer to the vehicle. The height adjustment mechanism is configured to couple the tow hitch to the vehicle. The height adjustment mechanism includes an actuator and a height sensor. The actuator is configured to linearly displace the tow hitch in a vehicle vertical direction. The height sensor detects a position of the tow hitch in the vehicle vertical direction. The electronic control unit is configured to: receive a trailer gross weight of the trailer; determine a tongue weight based on the trailer gross weight and the detected position of the tow hitch; calculate a ratio between the tongue weight and the trailer gross weight; and control the actuator to adjust the position of the tow hitch in the vehicle vertical direction such that the ratio between the tongue weight and the trailer gross weight is within a predetermined range.

In yet another embodiment, a method for adjusting a height of a tow hitch of a vehicle towing a trailer is provided. The vehicle having a height adjustment mechanism that couples the tow hitch to the vehicle. The height adjustment mechanism includes an actuator and a height sensor. The actuator is configured to linearly displace the tow hitch in a vehicle vertical direction. The height sensor detects a position of the tow hitch in the vehicle vertical direction. The method includes: receiving, by an electronic control unit, a trailer gross weight of the trailer; determining, by the electronic control unit, a tongue weight based on the trailer gross weight and the detected position of the tow hitch; calculating a ratio between the tongue weight and the trailer gross weight; and controlling the actuator to adjust the position of the tow hitch in the vehicle vertical direction such that the ratio between the tongue weight and the trailer gross weight is within a predetermined range.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts a side view of a vehicle and a trailer connected by a height adjusting tow hitch system, according to one or more embodiments shown and described herein;

FIG. 2 schematically depicts a partial enlarged side view, of area 2 of FIG. 1, of the height adjusting tow hitch system with a tow hitch coupled to a trailer coupler of the trailer, according to one or more embodiments shown and described herein;

FIG. 3 schematically depicts components of the height adjusting tow hitch system of FIG. 1, according to one or more embodiments shown and described herein;

FIG. 4A is a map illustrating a relationship between tow hitch height and tongue weight, according to one or more embodiments shown and described herein;

FIG. 4B is a map illustrating a relationship between tow hitch height and a ratio of tongue weight to trailer gross weight; and

FIG. 5 depicts a flowchart of an illustrative method for adjusting a height of a tow hitch of a vehicle towing a trailer, according to one or more embodiments shown and described.

### DETAILED DESCRIPTION

Embodiments described herein are directed to a height adjusting tow hitch system. In particular, a system that adjusts a height of a tow hitch of a vehicle to properly align the tow hitch with a trailer coupler of a trailer. The height of the tow hitch is adjusted in view of a ratio between a tongue weight and a trailer gross weight. The system includes: a tow hitch; a height adjustment mechanism; and an electronic control unit. The tow hitch is configured to couple the trailer to the vehicle. The height adjustment mechanism couples the tow hitch to the vehicle. The height adjustment mechanism includes an actuator and a height sensor. The actuator is configured to linearly displace the tow hitch in a vehicle vertical direction. The height sensor detects a position of the tow hitch in the vehicle vertical direction. The electronic control unit configured to: receive a trailer gross weight of the trailer; determine a tongue weight based on the trailer gross weight and the detected position of the tow hitch; calculate a ratio between the tongue weight and the trailer gross weight; and control the actuator to adjust the position of the tow hitch in the vehicle vertical direction such that the ratio between the tongue weight and the trailer gross weight is within a predetermined range. Various embodiments of the apparatus and operation of the apparatus are described in more detail herein. Whenever possible, the same reference numerals will be used throughout the drawings to refer to the same or like parts.

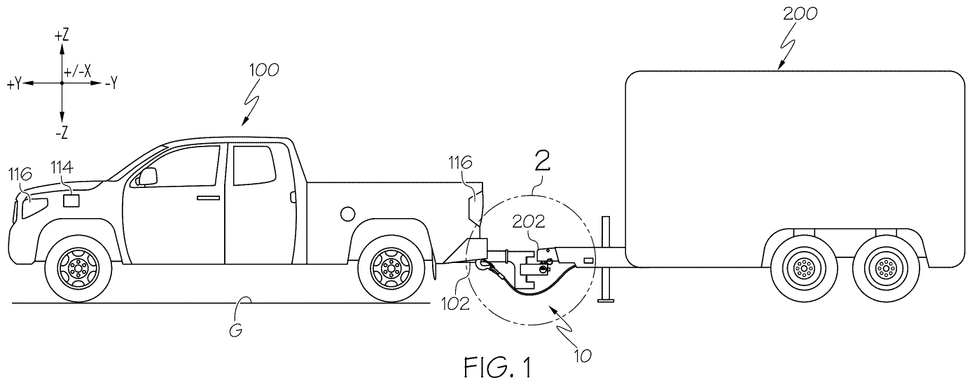

As used herein, the term “vehicle longitudinal direction” refers to the forward-rearward direction of the vehicle (i.e., in the +/−Y direction of the coordinate axes depicted in FIG. 1). The term “vehicle lateral direction” refers to the cross-vehicle direction (i.e., in the +/−X direction of the coordinate axes depicted in FIG. 1), and is transverse to the vehicle longitudinal direction. The term “vehicle vertical direction” refers to the upward-downward direction of the vehicle (i.e., in the +/−Z direction of the coordinate axes depicted in FIG. 1). As used herein, “upper” and “above” are defined as the positive Z direction of the coordinate axes shown in the drawings. “Lower” and “below” are defined as the negative Z direction of the coordinate axes shown in the drawings.

Referring now to FIG. 1, a height adjusting tow hitch system 10 is provided on a vehicle 100 configured to tow a trailer 200. Although FIG. 1 depicts an embodiment in which the vehicle 100 is configured as a pickup truck having a bed, with the height adjusting tow hitch system 10 mounted thereto, the height adjusting tow hitch system 10 may be used in any configuration of a vehicle (e.g., a passenger car, a van, a sport-utility vehicle, a crossover vehicle, etc.). As shown in FIG. 1, the trailer 200 is configured as an enclosed cargo trailer. However, the height adjusting tow hitch system 10 may be used with any configuration of a trailer (e.g., equipment trailers, travel trailers, utility trailers, vehicle hauling trailers, boat hauling trailers, etc.).

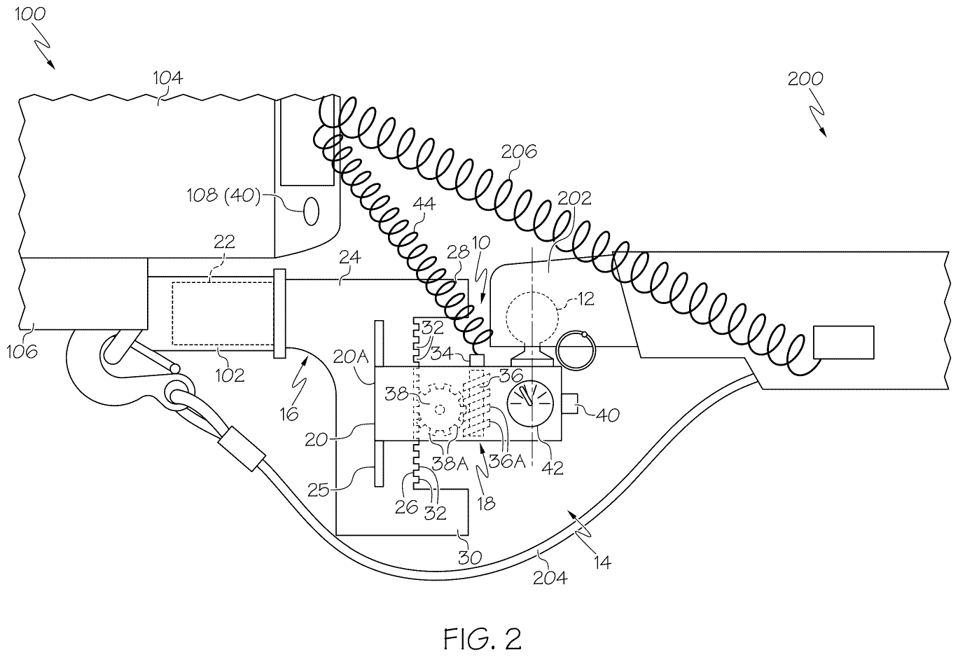

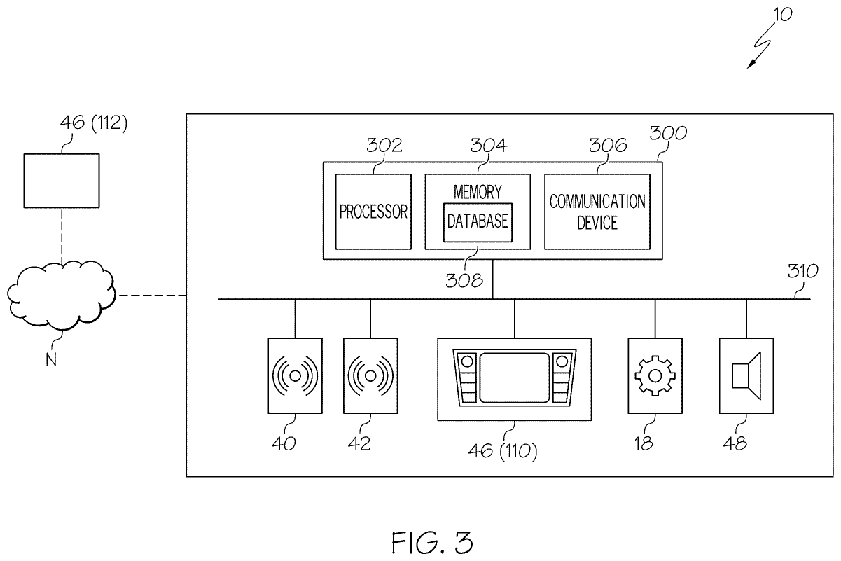

Referring to FIGS. 1-3, the vehicle 100 includes a hitch receiver 102 provided at a rear end 104 of the vehicle 100. The hitch receiver 102 is fixedly secured to a frame 106 of the vehicle 100. The height adjusting tow hitch system 10 includes a tow hitch 12, a height adjustment mechanism 14, and an electronic control unit 300, shown in FIG. 3. As illustrated in FIGS. 1 and 2, the tow hitch 12 is illustrated as a ball hitch. However, the tow hitch 12 is not limited to a ball hitch and may be any configuration of a hitch (e.g., a hook hitch, a shackle hitch, etc.).

The height adjustment mechanism 14 includes a hitch coupler 16, an actuator 18, and a tow hitch bracket 20. The hitch coupler 16 includes an attachment portion 22 and a mounting portion 24. The attachment portion 22 is at least partially received within the hitch receiver 102 to secure the height adjusting tow hitch system 10 to the vehicle 100. The tow hitch 12 is mounted on the tow hitch bracket 20. The tow hitch bracket 20 is coupled to the mounting portion 24 of the hitch coupler 16 by the actuator 18 to linearly displace the tow hitch bracket 20 and the tow hitch 12 in the vehicle vertical direction relative to a ground surface G, as discussed in greater detail below.

The mounting portion 24 has a generally C-shape with the attachment portion 22 extending outwardly therefrom. The mounting portion 24 includes a track 26 positioned between an upper stopper 28 and a lower stopper 30. The track 26 may include a plurality of engagement portions 32 that engage with the actuator 18 such that, even in an unpowered state, the tow hitch bracket 20 is inhibited from moving with respect to the track 26 of the hitch coupler 16 in the vehicle vertical direction without actuation of the actuator 18.

The actuator 18 has a fixed end secured to the tow hitch bracket 20 and a moveable end moveable coupled to the track 26 of the mounting portion 24. As illustrated in FIG. 2, the actuator 18 includes a motor 34, a worm gear 36, and a gear 38. The motor 34 is coupled to the tow hitch bracket 20 and configured to drive the worm gear 36 in a first direction and an opposite second direction to allow the worm gear 36 to rotate. The worm gear 36 includes a plurality of teeth 36A that engage with a plurality of teeth 38A of the gear 38. The gear 38 is rotatable attached to the tow hitch bracket 20. The teeth 38A of the gear 38 also engage with the engagement portions 32 of the track 26. The motor 34 drives the worm gear 36 in the first direction which drives the gear 38 in a third direction to linearly displace the tow hitch bracket 20, and consequently the tow hitch 12, upwardly in the vehicle vertical direction. Similarly, the motor 34 drives the worm gear 36 in the second direction which drives the gear 38 in a fourth direction to linearly displace the tow hitch bracket 20, and consequently the tow hitch 12, downwardly in the vehicle vertical direction. In use, the actuation of the actuator 18, such as driving of the motor 34, the worm gear 36, and the gear 38, linearly displaces the tow hitch bracket 20 and the tow hitch 12 in the vehicle vertical direction with respect to the hitch coupler 16, the mounting portion 24, the vehicle 100 and the ground surface G.

The upper stopper 28 and the lower stopper 30 are provided on an upper end and a lower end, respectively, of the track 26. The upper stopper 28 inhibits the linear displacement of the tow hitch bracket 20 and the tow hitch 12 upwardly in the vehicle vertical direction beyond a predetermined upper distance. The lower stopper 30 inhibits the linear displacement of the tow hitch bracket 20 and the tow hitch 12 downwardly in the vehicle vertical direction beyond a predetermined lower distance. The upper stopper 28 and the lower stopper 30 prevent the disengagement of the actuator 18 from the track 26.

In embodiments, the plurality of engagement portions 32 may be formed as a plurality of apertures formed in a surface of the track 26 and the teeth 38A of the gear 38 engage within the plurality of engagement portions 32, formed as the plurality of openings, to linearly displace the tow hitch bracket 20 and the tow hitch 12 upwardly or downwardly in the vehicle vertical direction. In embodiments, the plurality of engagement portions 32 may be formed as a plurality of protrusions extending outwardly from the surface of the track 26 and the teeth 38A of the gear 38 engage with the plurality of engagement portions 32, formed as the plurality of protrusions, to linearly displace the tow hitch bracket 20 and the tow hitch 12 upwardly or downwardly in the vehicle vertical direction.

The actuator 18 is not limited to the described configuration and may include any type of powered device that is configured to linearly displace the tow hitch bracket 20 and the tow hitch 12, with respect to the hitch coupler 16, in the vehicle vertical direction. In embodiments, the actuator 18 may be an electric motor, a linear actuator, a solenoid, a hydraulic cylinder, etc. In embodiments, the hitch coupler 16 may be formed with the track 26 and the actuator 18 may have the movable end secured to hitch coupler 16 and the fixed end secured to the mounting portion 24 to linearly displace the tow hitch bracket 20 and the tow hitch 12 in the vehicle vertical direction.

In embodiments, the tow hitch bracket 20 may include a protrusion 20A that engages with a slot 25 formed on side surfaces of the mounting portion 24. The protrusion 20A is slidingly coupled to the slot 25 to allow the tow hitch bracket 20 to be linearly displaced in the vehicle vertical direction while inhibiting the tow hitch bracket 20 from moving in the vehicle lateral direction and the vehicle longitudinal direction.

Still referring to FIG. 2, the height adjusting tow hitch system 10 includes a height sensor 40. The height sensor 40 is configured to detect a position of the tow hitch 12 in the vehicle vertical direction with respect to the ground surface G. The height sensor 40 may detect the position of the tow hitch 12 in the vehicle vertical direction by detecting a distance between the tow hitch 12 and the ground surface G. In embodiments, the position of the tow hitch 12 in the vehicle vertical direction is a distance between a top end of the tow hitch 12 and the ground surface G. The height sensor 40 may be a proximity sensor, an ultrasonic distance sensor, an infrared distance sensor, a LiDAR (Light Detection and Ranging) sensor, a LED time-of-flight distance sensor, or any other sensor configured to detect the position of the tow hitch 12 in the vehicle vertical direction with respect to the ground surface G.

In embodiments, the height sensor 40 may be coupled to the actuator 18, e.g. the motor 34, and detect the position of the tow hitch 12 based on a number of rotations of the motor 34. In embodiments, the height sensor 40 may be formed as a camera 108, such as a back up camera or a dedicated height detection camera, on the vehicle 100. The camera 108 may detect the position of the tow hitch 12 in the vehicle vertical direction based on image analysis.

In embodiments, the height adjusting tow hitch system 10 may include a tongue weight sensor 42 configured to detect a tongue weight TW on the tow hitch 12. The tongue weight TW detected by the tongue weight sensor 42 is the downward force exerted on the tow hitch 12 by the trailer 200. In embodiments, the tongue weight sensor 42 may be mounted onto the height adjusting tow hitch system 10 on the tow hitch bracket 20 and/or the hitch coupler 16. In embodiments, a plurality of tongue weight sensors 42 may be mounted or otherwise fixed to various locations of the height adjusting tow hitch system 10. Although FIG. 2 illustrates the tongue weight sensor 42 as having a gauge to allow the visual determination of the tongue weight TW, the tongue weight sensor 42 is not limited thereto. As described in greater detail below, the tongue weight sensor 42 may be in wired or wireless communication with the electronic control unit 300.

Referring to FIGS. 1 and 2, the trailer 200 includes a tongue coupler 202 configured to couple the trailer 200 to the tow hitch 12. The tongue coupler 202 is moveable between a locked position and an unlocked position. In the unlocked position, the tow hitch 12 is unsecured to the tongue coupler 202 to allow for the tow hitch 12 to be inserted and removed from the tongue coupler 202. In the locked position, the tow hitch 12 is secured to the tongue coupler 202 to prevent movement of the tow hitch 12 with respect to the tongue coupler 202 and allow the vehicle 100 to tow the trailer 200.

The trailer 200 may also include a connector 204 having one end coupled to the trailer 200 and an opposite end coupled to the frame 106 of the vehicle 100. The trailer 200 also includes a trailer wiring cable 206 that electrically connects the vehicle 100 to the trailer 200. The trailer wiring cable 206 transmits signals for brake lights, turn signals, and other electrical functions necessary for operation of the trailer 200. In embodiments, the height adjusting tow hitch system 10 includes an electronic cable 44 that electrically connects the vehicle 100 to the actuator 18. The electronic cable 44 electrically connects the actuator 18 to the electronic control unit 300 such that the electronic control unit 300 is configured to control the actuation of the actuator 18. In embodiments, the actuator 18 is wireless connected to the electronic control unit 300 such that the electronic control unit 300 is configured to control the actuation of the actuator 18. In embodiments, the electronic cable 44 supplies power to the actuator 18, for example the motor 34, to power the actuator 18 to linearly displace the tow hitch 12 in the vehicle vertical direction. In embodiments, the electronic cable 44 may connect to the vehicle 100 at the vehicle connection of the trailer wiring cable 206. In embodiments, the electronic cable 44 may be independent of the trailer wiring cable 206.

FIG. 3 schematically depicts the height adjusting tow hitch system 10, the electronic control unit 300, the height sensor 40, the tongue weight sensor 42, an input device 46, the actuator 18, and an alarm output device 48. The electronic control unit 300 includes at least one processor 302, a memory 304, and a communication device 306. The processor 302 may include any processing component configured to receive and execute instructions (such as from the memory 304). An interface 310 is included and may be implemented as a bus, or other interface to facilitate wired or wireless communication between the electronic control unit 300, the height sensor 40, the tongue weight sensor 42, an input device 46, the actuator 18, and the alarm output device 48.

The memory 304 may be configured as volatile and/or nonvolatile computer readable medium and, as such, may include random access memory (including SRAM, DRAM, and/or other types of random access memory), flash memory, registers, compact discs (CD), digital versatile discs (DVD), and/or other types of storage components.

The communication device 306 may include any wired or wireless networking hardware, such as a modem, LAN port, wireless fidelity (Wi-Fi) card, WiMax card, mobile communications hardware, and/or other hardware for communicating with other networks and/or devices. The communication device 306 allows for the electronic control unit 300 to communicate with the height sensor 40, the tongue weight sensor 42, the input device 46 (including a human machine interface 110 and a mobile terminal 112), the actuator 18, and the alarm output device 48.

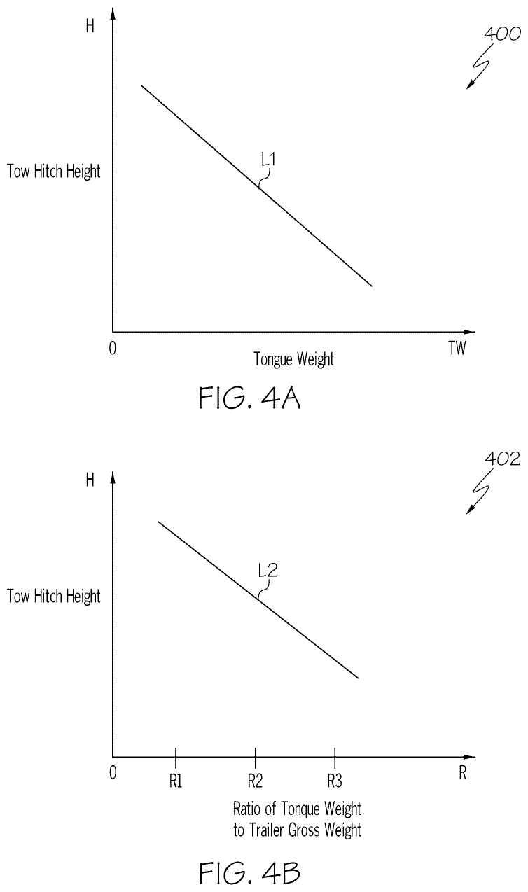

Additionally, the memory 304 includes a database 308 configured to store a first map 400 defining a relationship between the position of the tow hitch 12 in the vehicle vertical direction (i.e. tow hitch height H) and tongue weight TW, as shown in FIG. 4A. The database 308 is also configured to a second map 402 defining a relationship between the tow hitch height H and a ratio R between the tongue weight TW and a trailer gross weight TGW, as shown in FIG. 4B. The first map 400 and the second map 402 are prestored in the database 308 of memory 304. In embodiments, the first map 400 is created by experimentation and charting the relationship between the tow hitch height H and the tongue weight TW. In embodiments, the database 308 includes a plurality of first maps 400, the plurality of first maps 400 corresponding to a plurality of trailer gross weights TGW and each of the plurality of first maps 400 chart the relationship between the tow hitch height H and the tongue weight TW for a particular trailer gross weight TGW. In embodiments, the second map 402 is created by experimentation to chart the relationship between the tow hitch height H and the ratio R between the tongue weight TW and the trailer gross weight TGW. In embodiments, the database 308 includes a plurality of second maps 402 corresponding to a plurality of trailer gross weights TGW and each of the plurality of second maps 402 chart the relationship between the tow hitch height H and the ratio R between the tongue weight TW and the trailer gross weight TGW for a particular trailer gross weight TGW.

The input device 46 may be a human machine interface 110 that is provided inside of the vehicle 100. For example, the human machine interface 110 may be an infotainment system of the vehicle 100. The human machine interface 110 has a plurality of inputs to allow a user to enter a trailer gross weight, as discussed in greater detail below. In embodiments, the input device 46 may be a mobile terminal 112 such as smart phone, a mobile computer, or any other device configured to receive an input from the user and transmit the input to the electronic control unit 300. In embodiments, the mobile terminal 112 may be connected to the communication device 306 via a network N such as a cellular network or an internet.

The alarm output device 48 is configured to emit a visual indicator and/or an auditory indicator around the vehicle 100. By emitting the visual indicator and/or the auditory indicator, attention is drawn to the height adjusting tow hitch system 10 and the user may be indicated that a situation requires attention, as discussed in greater detail below. The alarm output device 48 may include a plurality of external vehicle lights 116 that are configured to illuminate as a visual indicator. The plurality of external vehicle lights 116 may include one or more of a headlight, a tail light, a reverse indicator light, a daytime running lamp, an indicator light, a cargo light, etc. that may illuminate as the visual indicator. The plurality of external vehicle lights 116 may be activated in a repetitive (e.g., flashing), continuous, or any other suitable illumination pattern. The alarm output device 48, a horn 114 of the vehicle 100, is configured to emit a sound as an auditory indicator. The horn 114 may emit the sound repetitively, continuously, or in any other suitable pattern. The horn 114 may be activated in a repetitive, continuous, or any other suitable audio pattern. It is to be appreciated that the alarm output device 48 may include any component suitable for producing the visual indicator and/or the auditory indicator.

Referring to FIG. 4A, the relationship between the tow hitch height H and the tongue weight TW is illustrated as line L1 on a first map 400. It is appreciated that the relationship between the tow hitch height H and the tongue weight TW may not be linear. As shown in FIG. 4A, the first map 400 illustrates that as the tow hitch height H increases the tongue weight TW decreases. Referring now to FIG. 4B, the relationship between the tow hitch height H and the ratio R of the tongue weight TW and the trailer gross weight TGW is illustrated as L2 on a second map 402. As the tongue weight TW decreases as the tow hitch height H increases, the ratio R of the tongue weight TW to the trailer gross weight TGW also decreases as the tow hitch height H increases. In embodiments, the ratio of the tongue weight TW to the trailer gross weight TGW is defined as a percentage between of the tongue weight TW to the trailer gross weight TGW.

Still referring to FIG. 4B, a predetermined range of the ratio of the tongue weight TW to the trailer gross weight TGW is stored in advance. In embodiments, the predetermined range is that the tongue weight TW is 10 to 15% of the trailer gross weight TGW. In embodiments, the predetermined range may vary by ±1%, ±2%, ±3%, ±4%, or ±5% so that the tongue weight TW is 10 to 15% of the trailer gross weight TGW. As shown in FIG. 4B, the predetermined range has a lower threshold R1 and an upper threshold R2 that defines the predetermined range of the ratio R of tongue weight TW to trailer gross weight TGW. Still referring to FIG. 4B, an alarm maximum R3 of the ratio of the tongue weight TW to the trailer gross weight TGW is provided.

It is appreciated that the vehicle 100 may have a gross vehicle weight rating determining a maximum weight that the vehicle 100 is configured to tow. In embodiments, the alarm maximum R3 is stored based on the gross vehicle weight rating for the vehicle 100. As discussed in greater detail below, the alarm output device 48 may issue audio indicator and/or the visual indicator when the alarm maximum R3 is exceeded.

In order to facilitate a better understanding of the height adjusting tow hitch system 10, the operation of the height adjusting tow hitch system 10 will be discussed. In operation, a user installs the height adjusting tow hitch system 10 to the vehicle 100. Specifically, the attachment portion 22 is inserted and secured to the hitch receiver 102. The tow hitch 12 is coupled to the tongue coupler 202.

In embodiments, the user may actuate the input device 46 to move the tow hitch bracket 20 and the tow hitch 12 to a lowermost position in the vehicle vertical direction. In the lowermost position, the tow hitch bracket 20 is inhibited from moving downwardly in the vehicle direction by the lower stopper 30. Specifically, upon actuation of the input device 46, the electronic control unit 300 receives a signal from the input device 46 via the communication device 306, and the electronic control unit 300 controls the actuator 18 to linearly displace in the vehicle vertical direction to the lowermost position.

Upon coupling the tow hitch 12 to the tongue coupler 202, the user inputs the trailer gross weight TGW of the trailer 200 into the input device 46. The input device 46 transmits the input trailer gross weight TGW to the electronic control unit 300. The height sensor 40 detects a position of the tow hitch 12 in the vehicle vertical direction with respect to the ground surface G. The position of the tow hitch 12 in the vehicle vertical direction corresponds to the tow hitch height H. The electronic control unit 300 receives the trailer gross weight TGW and determines the tongue weight TW based on the received tongue weight TW and the detected position of the tow hitch 12 in the vehicle vertical direction.

In order to determine the tongue weight TW, the electronic control unit 300 accesses the first map 400 of the relationship between the tow hitch height H and tongue weight TW. In embodiments, the electronic control unit 300 selects the first map 400 of the plurality of first maps 400 that corresponds to the received trailer gross weight TGW. Utilizing the first map 400, the electronic control unit 300 determines the tongue weight TW based on the detected position of the tow hitch 12 in the vehicle vertical direction (e.e. the tow hitch height H) and the received trailer gross weight TGW. The electronic control unit 300 calculates the ratio R of the tongue weight TW and the trailer TGW utilizing the second map 402. In embodiments, the electronic control unit 300 selects the second map 402 of the plurality of second maps 402 that corresponds to the received trailer gross weight TGW. Alternatively, the electronic control unit 300 receives the tongue weight TW from the tongue weight sensor 42.

Upon calculating the ratio R of the tongue weight TW and the trailer gross weight TGW, the electronic control unit 300 controls the actuator 18 to adjust the position of the tow hitch 12 in the vehicle vertical direction such that the ratio R of the tongue weight TW and the trailer gross weight TGW is within the predetermined range. Specifically, the electronic control unit 300 controls the actuator 18 to adjust the position of the tow hitch 12 in the vehicle vertical direction such that the ratio R of the tongue weight TW and the trailer gross weight TGW is witin the predetermined range defined by the lower threshold R1 and the upper threshold R2.

In embodiments, the electronic control unit 300 continuously calculates the ratio R of the tongue weight TW and the trailer gross weight TGW as the electronic control unit 300 controls the actuator 18 to linearly displace the tow hitch 12 in the vehicle vertical direction to adjust the position of the tow hitch 12 in the vehicle vertical direction. In embodiments, the electronic control unit 300 intermittently adjusts the position of the tow hitch 12 and calculates the ratio R of the tongue weight TW and the trailer gross weight TGW. Specifically, the electronic control unit 300 linearly displaces the tow hitch 12 by a predetermined amount and then calculates the ratio R of the tongue weight TW and the trailer gross weight TGW. If the ratio R of the tongue weight TW and the trailer gross weight TGW is not within the predetermined range after linearly displacing the tow hitch 12 by the predetermined amount, the electronic control unit 300 linearly displaces the tow hitch 12 in the vehicle vertical direction by the predetermined amount again. The electronic control unit 300 continues to linearly displace the tow hitch 12 in the vehicle vertical direction and then calculates the ratio R of the tongue weight TW and the trailer gross weight TGW until the ratio R of the tongue weight TW and the trailer gross weight TGW is within the predetermined range. Once the ratio R of the tongue weight TW and the trailer gross weight TGW is within the predetermined range, the electronic control unit 300 stops the control of the actuator 18 as the tow hitch 12 and the trailer 200 are properly aligned.

In embodiments including the tongue weight sensor 42, the electronic control unit 300 uses the tongue weight TW detected by the tongue weight sensor 42 to determine the tongue weight.

In embodiments, the electronic control unit 300 determines that the tow hitch 12 is coupled to the trailer 200 using the camera 108. After the user inputs the trailer gross weight TGW and upon determination that the tow hitch 12 is coupled to the trailer, the electronic control unit 300 automatically controls the actuator 18 to linearly displace the tow hitch 12 in the vehicle vertical direction until the ratio of the tongue weight TW and the trailer gross weight TGW is within the predetermined range.

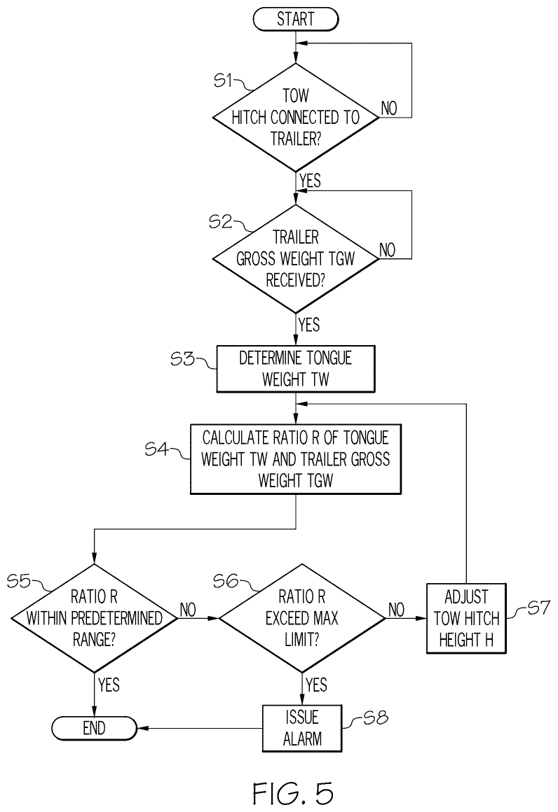

Referring now to FIG. 5, a method is depicted for adjusting a height of the tow hitch 12 using the height adjusting tow hitch system 10. The method is discussed with reference to the height adjusting tow hitch system 10 illustrated in FIGS. 1-3, including the vehicle 100, the trailer 200, and the individual components of the height adjusting tow hitch system 10 described herein. The method is operated by the electronic control unit 300. In embodiments, the method is executed by the processor 302 executing instructions stored in the memory 304.

At step S1, it is determined whether the tow hitch 12 is connected to the tongue coupler 202. The determination in step S1 may be made by the user using the input device 46. The determination in step S1 may be made by the electronic control unit 300 determining that the tow hitch 12 is connected to the tongue coupler 202 based on an image analysis of an image taken by the camera 108. The determination in step S1 may be made by the electronic control unit 300 receiving a signal that the trailer wiring cable 206 is connected to the vehicle 100.

When the determination is negative (No in S1), the method proceeds to continuous execute step S1 until a positive determination is made. When the determination is positive (Yes in step S1), the method proceeds to step S2. In step S2, it is determined whether the trailer gross weight TGW is received. The trailer gross weight TGW may be entered by the user via the input device 46. In embodiments, the trailer gross weight TGW may be determined by sensors associated with the vehicle 100 or trailer 200.

When the determination is negative (No in S2), the method proceeds to continuous execute step S2 until a positive determination is made. When the determination is positive (Yes in step S2), the method proceeds to step S3. In step S3, the tongue weight TG is determined. The tongue weight TG may be determined by the electronic control unit 300 using the tongue weight sensor 42. The tongue weight TG may be determined by the electronic control unit 300 by first detecting the position of the tow hitch 12 (tow hitch height H) using the height sensor 40. Based on the detected tow hitch height H and the received trailer gross weight TGW, the electronic control unit 300 determines the tongue weight TW by utilizing the first map 400 prestored in the database 308 of memory 304. The electronic control unit 300 may determine the tongue weight TW by utilizing the first map 400 of the plurality of first maps 400 that corresponds to the received trailer gross weight TGW.

In step S4, the ratio R of tongue weigh TW and trailer gross weight TGW is calculated. The ratio of tongue weigh TW and trailer gross weight TGW may be determined by the electronic control unit 300 by based on the detected tow hitch height H and the determined tongue weight TW by utilizing the second map 402 prestored in the database 308 of memory 304. The electronic control unit 300 may determine the ratio of tongue weigh TW and trailer gross weight TGW by utilizing the second map 402 of the plurality of second maps 402 that corresponds to the received trailer gross weight TGW. The electronic control unit 300 may calculate the ratio of tongue weigh TW and trailer gross weight TGW by dividing the tongue weight TW by the received trailer gross weight TGW.

In step S5, it is determined whether the calculated ratio R of the tongue weight TW and the trailer gross weight TGW is within the predetermined range. The electronic control unit 300 determines whether the ratio R of the tongue weight TW and the trailer gross weight TGW is within the predetermined range by utilizing the second map 402 prestored in the database 308 of memory 304. The electronic control unit 300 may determine the ratio of tongue weigh TW and trailer gross weight TGW by utilizing the second map 402 of the plurality of second maps 402 that corresponds to the received trailer gross weight TGW.

When the determination is positive (Yes in S5), the method ends. When the determination is negative (No in step S5), the method proceeds to step S6. In step S6, it is determined whether the calculated ratio R of the tongue weight TW and the trailer gross weight TGW exceeds the alarm maximum R3. When the determination is positive (Yes in S6), the method proceeds to step S8. In step S8, the electronic control unit 300 controls the alarm output device 48 to issue the visual indicator and/or the auditory indicator to alert the user of the situation. After step S8, the method ends. When the determination is negative (No in step S6), the method proceeds to step S7.

In step S7, the tow hitch height H is adjusted in the vehicle vertical direction with respect to the ground surface G. The tow hitch height H is adjusted by the electronic control unit 300 controlling the actuator 18 to linearly displace the tow hitch 12 in the vehicle vertical direction with respect to ground surface G. When the calculated ratio R of the tongue weight TW and the trailer gross weight TGW is below the lower threshold R1, the electronic control unit 300 controls the actuator 18 to lower the tow hitch 12 downwardly in the vehicle vertical direction with respect to the ground surface G. When the calculated ratio R of the tongue weight TW and the trailer gross weight TGW is above the upper threshold R2, the electronic control unit 300 controls the actuator 18 to raise the tow hitch 12 upwardly in the vehicle vertical direction with respect to the ground surface G. After step S7, the method returns to step S4 and continuously operates until it is determined that the calculated ratio R of the tongue weight TW and the trailer gross weight TGW is within the predetermined range in step S5.

While particular embodiments have been illustrated and described herein, it should be understood that various other changes and modifications may be made without departing from the scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A height adjusting tow hitch system for a vehicle towing a trailer, the system comprising:
a tow hitch configured to couple the trailer to the vehicle;
a height adjustment mechanism that couples the tow hitch to the vehicle, the height adjustment mechanism having an actuator and a height sensor, the actuator configured to linearly displace the tow hitch in a vehicle vertical direction, the height sensor detects a position of the tow hitch in the vehicle vertical direction; and
an electronic control unit configured to:
receive a trailer gross weight of the trailer;
determine a tongue weight based on the trailer gross weight and the detected position of the tow hitch;
calculate a ratio between the tongue weight and the trailer gross weight; and
control the actuator to adjust the position of the tow hitch in the vehicle vertical direction such that the ratio between the tongue weight and the trailer gross weight is within a predetermined range.

2. The height adjusting tow hitch system of claim 1, wherein the height adjustment mechanism includes a track, the tow hitch being coupled to the track and the actuator configured to linearly displace the tow hitch in the vehicle vertical direction along the track.

3. The height adjusting tow hitch system of claim 2, wherein the actuator is a worm gear that engages with the track to linearly displace the tow hitch in the vehicle vertical direction.

4. The height adjusting tow hitch system of claim 1, wherein the height sensor is a camera.

5. The height adjusting tow hitch system of claim 1 further comprising an input device configured for a user to input the trailer gross weight.

6. The height adjusting tow hitch system of claim 5, wherein the input device is a human machine interface providing in the vehicle.

7. The height adjusting tow hitch system of claim 6, wherein the input device is a mobile terminal.

8. The height adjusting tow hitch system of claim 1 further comprising a tongue weight sensor that detects the tongue weight,
wherein the electronic control unit determines the tongue weight based on the detected tongue weight.

9. A vehicle configured to tow a trailer, the vehicle comprising
a tow hitch configured to couple the trailer to the vehicle;
a height adjustment mechanism that couples the tow hitch to the vehicle, the height adjustment mechanism having an actuator and a height sensor, the actuator configured to linearly displace the tow hitch in a vehicle vertical direction, the height sensor detects a position of the tow hitch in the vehicle vertical direction; and
an electronic control unit configured to:
receive a trailer gross weight of the trailer;
determine a tongue weight based on the trailer gross weight and the detected position of the tow hitch;
calculate a ratio between the tongue weight and the trailer gross weight; and
control the actuator to adjust the position of the tow hitch in the vehicle vertical direction such that the ratio between the tongue weight and the trailer gross weight is within a predetermined range.

10. The vehicle of claim 9, wherein the height adjustment mechanism includes a track, the tow hitch being coupled to the track and the actuator configured to linearly displace the tow hitch in the vehicle vertical direction along the track.

11. The vehicle of claim 10, wherein the actuator is a worm gear that engages with the track to linearly displace the tow hitch in the vehicle vertical direction.

12. The vehicle of claim 9, wherein the height sensor is a camera.

13. The vehicle of claim 9 further comprising an input device configured for a user to input the trailer gross weight.

14. The vehicle of claim 13, wherein the input device is a human machine interface providing in the vehicle.

15. The vehicle of claim 14, wherein the input device is a mobile terminal.

16. The vehicle of claim 9 further comprising a tongue weight sensor that detects the tongue weight,
wherein the electronic control unit determines the tongue weight based on the detected tongue weight.

17. A method for adjusting a height a tow hitch of a vehicle towing a trailer, the vehicle having
a height adjustment mechanism that couples the tow hitch to the vehicle, the height adjustment mechanism having an actuator and a height sensor, the actuator configured to linearly displace the tow hitch in a vehicle vertical direction, the height sensor detects a position of the tow hitch in the vehicle vertical direction, the method comprising:
receiving, by an electronic control unit, a trailer gross weight of the trailer;
determining, by the electronic control unit, a tongue weight based on the trailer gross weight and the detected position of the tow hitch;
calculating a ratio between the tongue weight and the trailer gross weight; and
controlling the actuator to adjust the position of the tow hitch in the vehicle vertical direction such that the ratio between the tongue weight and the trailer gross weight is within a predetermined range.

18. The method of claim 17, wherein the trailer gross weight is received from an input device.

19. The method of claim 18, wherein the input device is a human machine interface provided in the vehicle.

20. The method of claim 18, wherein the input device is a mobile terminal.
